(19) United States
(12) Patent Application Publication
(10) Pub. No.: US 2017/0345108 A1
(43) Pub. Date: Nov. 30, 2017

(54) METHOD FOR RECOMMENDING A VACATION OPTION

(71) Applicant: MASTERCARD INTERNATIONAL INCORPORATED, Purchase, NY (US)

(72) Inventors: Sharan Bakshiram, Purchase, NY (US); Avyaktanand Tiwary, Gurgaon (IN); Shashank Dubey, Jabalpur (IN)

(21) Appl. No.: 15/603,706

(22) Filed: May 24, 2017

(30) Foreign Application Priority Data
May 27, 2016 (SG) 10201604318P

(51) Int. Cl. G06Q 50/14; G06Q 20/10

(52) U.S. Cl. CPC G06Q 50/14; G06Q 20/10

(57) ABSTRACT

A computer-implemented method for recommending a vacation option for an account holder is provided, including: retrieving historical vacation transaction data relating to a plurality of historical vacation transactions settled for the account holder; processing the historical vacation transaction data to identify vacation characteristics relating to the account holder and a vacation budget representing an amount that the account holder is likely to spend on vacation travel, the vacation characteristics indicating a preferred weather under which the account holder has visited vacation venues identified by the historical vacation transaction data and a preferred time period during which the account holder has visited the vacation venues; retrieving a list of vacation options each associated with a budget that is within the identified vacation budget of the account holder; and recommending a vacation option from the retrieved list of vacation options based on the identified vacation characteristics.

### FIELD OF INVENTION

The present invention relates broadly, but not exclusively, to methods for recommending a vacation option.

### BACKGROUND

There are various avenues that can be used for planning vacations. Since the advent of the internet, a lot of online avenues such as online travel agencies have come up which assist users in planning vacations. However, most of that information is quite static in its nature and very catered to an user doing research. This is of very little use to the typical user who often does research on same locations and wants to know where to go to meet like-minded people.

Moreover, the impact of weather is direct and dramatic on many facets of vacation travel. However, it is a factor that is often not considered during vacation planning. For example, it is best to avoid water activities or sea travel during monsoon season. For another example, it is best to travel to Japan during spring to view cherry blossoms. For unfamiliar customers, they may not be aware of the best weather to visit a place.

A need therefore exists to provide methods for recommending a vacation option that addresses one or more of the above problems.

Furthermore, other desirable features and characteristics will become apparent from the subsequent detailed description and the appended claims, taken in conjunction with the accompanying drawings and this background of the disclosure.

### SUMMARY

In the first aspect of the invention, a computer-implemented method for recommending a vacation option for an account holder is provided, comprising: retrieving historical vacation transaction data relating to a plurality of historical vacation transactions settled for the account holder; processing the historical vacation transaction data to identify vacation characteristics relating to the account holder and a vacation budget representing an amount that the account holder is likely to spend on vacation travel, the vacation characteristics indicating a preferred weather under which the account holder has visited vacation venues identified by the historical vacation transaction data and a preferred time period during which the account holder has visited the vacation venues; retrieving a list of vacation options each associated with a budget that is within the identified vacation budget of the account holder; and recommending a vacation option from the retrieved list of vacation options based on the identified vacation characteristics.

In an embodiment, the step of processing the historical transaction data further comprises: determining one merchant category in which the account holder has initiated at least a historical vacation transaction; and determining a vacation type representing a category of vacation travel in which the account holder is interested based on the determined merchant category.

In an embodiment, the step of recommending the vacation option further comprises selecting the vacation option that satisfies the determined vacation type.

In an embodiment, the vacation budget is identified by determining an average expenditure that the account holder has spent on vacation based on the merchant category.

In an embodiment, the vacation option is recommended based on a relevance score which indicates a relevance of the vacation option based on the identified vacation characteristics of the account holder.

In an embodiment, the method further comprises recommending a second vacation option from the retrieved list of vacation options based on the identified vacation characteristics of the account holder; and assigning a relevance score to the second vacation option.

In an embodiment, the method further comprises ranking the vacation options based on the relevance scores.

In an embodiment, the method further comprises determining a popularity score for the time period during which the account holder has done the activities.

In an embodiment, the step of recommending the vacation option is done based on the determined popularity score.

According to the second aspect of the invention, an apparatus recommending a vacation option for an account holder is provided, comprising:
at least one processor; and
at least one memory including computer program code;
the at least one memory and the computer program code configured to, with at least one processor, cause the apparatus at least to:
retrieve historical vacation transaction data relating to a plurality of historical vacation transactions settled for the account holder;
process the historical vacation transaction data to identify vacation characteristics relating to the account holder and a vacation budget representing an amount that the account holder is likely to spend on vacation travel, the vacation characteristics indicating a preferred weather under which the account holder has visited vacation venues identified by the historical vacation transaction data and a preferred time period during which the account holder has visited the vacation venues;
retrieve a list of vacation options each associated with a budget that is within the identified vacation budget of the account holder; and
   recommend a vacation option from the retrieved list of vacation options based on the identified vacation characteristics.

In an embodiment, the at least one memory and the computer program code is further configured with the at least one processor to:
determine one merchant category in which the account holder has initiated at least a historical vacation transaction; and
determine a vacation type representing a category of vacation travel in which the account holder is interested based on the determined merchant category.

In an embodiment, the at least one memory and the computer program code is further configured with the at least one processor to: select the vacation option that satisfies the determined vacation type.

In an embodiment, the vacation budget is identified by determining an average expenditure that the account holder has spent on vacation based on the merchant category.

In an embodiment, the vacation option is recommended based on a relevance score which indicates a relevance of the vacation option based on the identified vacation characteristics of the account holder.

In an embodiment, the at least one memory and the computer program code is further configured with the at least one processor to:
recommend a second vacation option from the retrieved list of vacation options based on the identified vacation characteristics of the account holder; and
assign a relevance score to the second vacation option.

In an embodiment, the at least one memory and the computer program code is further configured with the at least one processor to: rank the vacation options based on the relevance scores.

In an embodiment, the at least one memory and the computer program code is further configured with the at least one processor to: determine a popularity score for the time period during which the account holder has visited the vacation venues.

In an embodiment, the at least one memory and the computer program code is further configured with the at least one processor to: recommend the vacation option is done based on the determined popularity score.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a block diagram of a transaction system 100 within which transaction data can be received.

FIG. 2 shows a flow chart illustrating a computer-implemented method for recommending a vacation option according to an example embodiment.

FIG. 3 shows a schematic diagram of a computer system suitable for use in executing the method depicted in FIG. 2.

FIG. 4 shows an exemplary computing device to realize a server for the payment network server 108 shown in FIG. 1.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “receiving”, “retrieving”, “identifying”, “predicting”, “processing”, “retrieving” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present invention relate to methods for recommending a vacation option for an account holder. In an embodiment, the method is a computer-implemented method which recommends a vacation option for an account holder.

In the following description, a payment card is a card that can be used by an account holder for a transaction with a merchant. In the following description, the term “payment cards” refer to any suitable transaction cards, such as credit cards, debit cards, prepaid cards, charge cards, membership cards, promotional cards, frequent flyer cards, identification cards, gift cards, and/or any other device that may hold payment account information, such as mobile phones, Smartphones, personal digital assistants (PDAs), key fobs, and/or computers. Each type of payment card can be used as a method of payment for performing a transaction.

In the following description, an account holder (or a customer) may refer to a payment card user. The account holder is a customer who initiates a transaction with a merchant. In one example, the customer may initiate the transaction with the merchant to buy goods and/or services from the merchant using his payment card. In embodiments below, the merchant may be one who is related to vacation-type transaction. That is, the merchant may be, among other things, a travel agent, a hotel, a rental car provider. In an embodiment, the transaction is a payment transaction. In other words, completion of the transaction involves a payment between parties to the transaction.

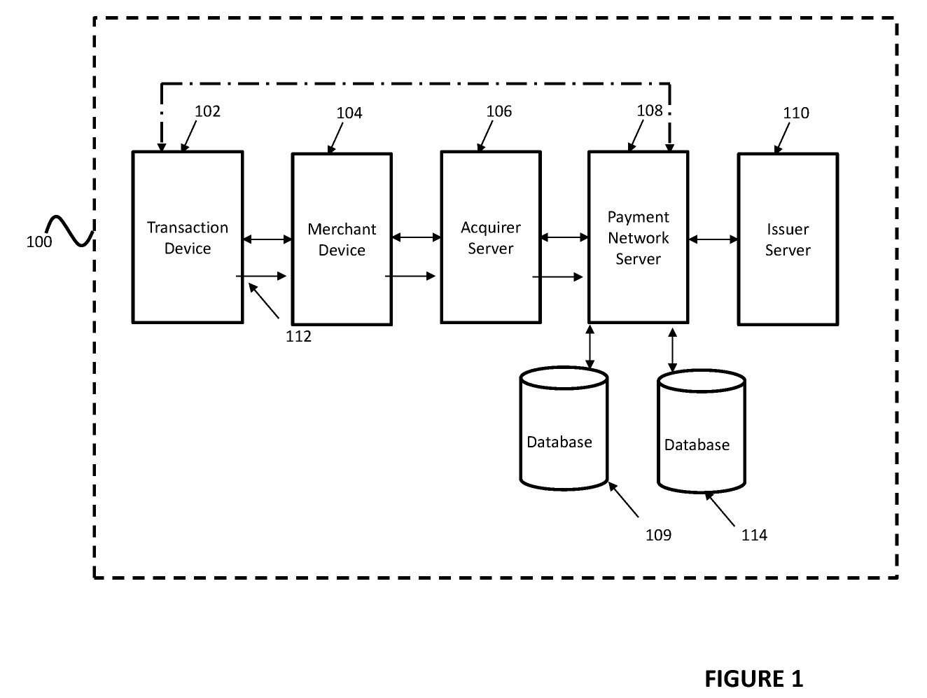

FIG. 1 illustrates a block diagram of a transaction system 100 within which transaction data can be received.

The system 100 comprises a transaction device 102 in communication with a merchant device 104. The transaction device 102 may also be in direct communication with a payment network server 108, without having to communicate with the merchant device 104.

The merchant device 104 is in communication with an acquirer server 106. The acquirer server 106, in turn, is in communication with a payment network server 108. The payment network server 108, in turn, is in communication with an issuer server 110.

Use of the term ‘server’ herein can mean a single computing device or a plurality of interconnected computing devices which operate together to perform a particular function. That is, the server may be contained within a single hardware unit or be distributed among several or many different hardware units.

The transaction device 102 typically is associated with a customer who is a party to a transaction that occurs between the transaction device 102 and the merchant device 104 through a transaction. The transaction device 102 may be a fixed (wired) computing device or a wireless (portable) computing device. In specific implementations, the transaction device 102 may be a handheld or portable or mobile device carried or used by the customer, or may refer to other types of electronic devices such as a personal computer, a land-line telephone or an interactive voice response (IVR) system and the like. The mobile device may be a device, such as a mobile phone, a tablet computer, a laptop computer, a personal digital assistant (PDA), a mobile computer, a portable music player (such as an iPod™ and the like).

The merchant device 104 typically is associated with the merchant who is also a party to the transaction that occurs between transaction device 102 and the merchant device 104 through the transaction. The merchant device 104 may be a point-of-sale (POS) terminal, an automatic teller machine (ATM), a personal computer, a computer server (hosting a website, for example), an interactive voice response (IVR) system, a land-line telephone, or any type of mobile device such as a mobile phone, a PDA, a laptop computer, a tablet computer and the like.

The acquirer server 106 generally is associated with an acquirer which may be an entity (e.g. a company or organization) which issues (e.g. establishes, manages, administers) a transaction credential or an account (e.g. a financial bank account) of the merchant. Examples of the acquirer include a bank and/or other financial institution. As stated in the above, the acquirer server 106 may include one or more computing devices that are used to establish communication with another server by exchanging messages with and/or passing information to the other server.

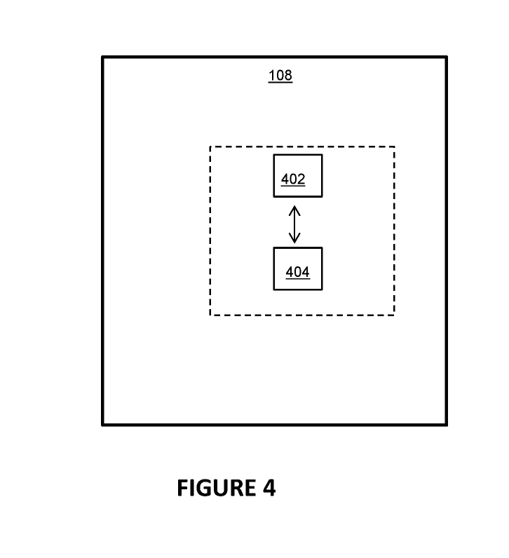

The payment network server 108 typically is associated with a payment facilitator. For example, the payment network server 108 may be the Banknet® network operated by MasterCard®. The payment facilitator (e.g. MasterCard®) may be an organization which operates to process transactions, clear and settle funds for payments between two entities (e.g. two banks). The payment network server 108 may include one or more computing devices that are used for processing transactions. An exemplary payment network server 108 is shown in FIG. 4.

The issuer server 110 generally is associated with an issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of transaction devices 102.

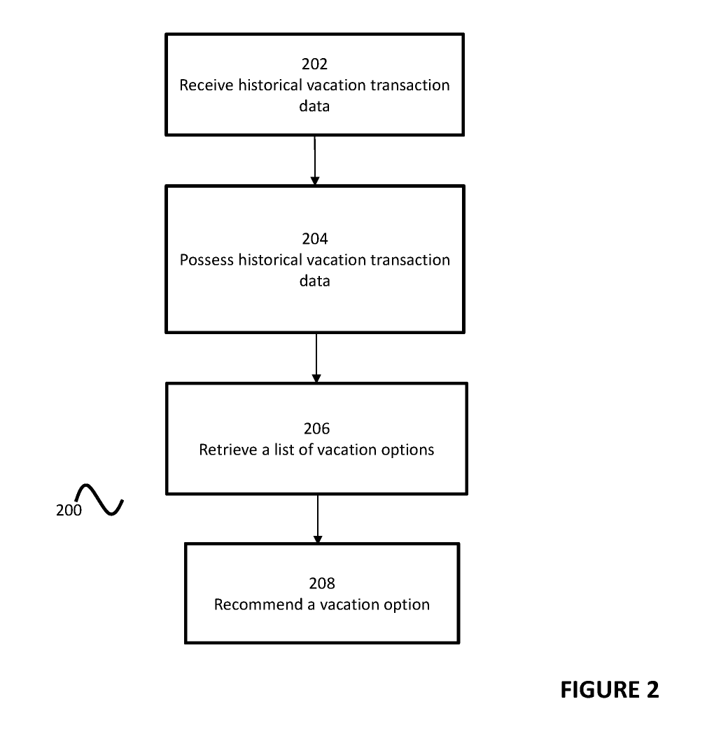

The payment network server 108 may be configured to communicate with, or may include, a database 109. The database 109 stores data corresponding to each account issued by the issuer and data corresponding to a transaction. Examples of the data include Transaction ID, Merchant ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant, time and date for which the goods/services relating to the transaction will be delivered are included in the database 109. Further details on this data are described in FIG. 2 below.

In specific implementations, the payment network server 108 may also be configured to communicate with, or include, another database 114. The database 114 may be separate from the database 109. Alternatively, the database 114 may be included in the database 109. The database 114 stores a respective popularity index for each of a plurality of additional merchants. The popularity indexes may include review(s) of one of the additional merchant from a customer or the number of times a customer visits a merchant. The plurality of additional merchants may or may not include the merchants with whom the account holder is initiating a transaction. A popularity index for each of these additional merchants is obtained via recommendation-providing social media platforms such as Foursquare™ or Facebook™ or recommendation-providing web sites such as TripAdvisor™.

In an example, during a transaction, a transaction request message 112 is generated at the transaction device 102. The transaction request message 112 is generated by the transaction device 102 in response to the customer making a selection of a good and/or service to be purchased from the merchant. In specific implementations of the present invention, the merchant that sells the good and/or service may or may not be the entity (or merchant) delivering it. For example, a trip to Hong Kong Disneyland™ may be purchased from a website of a travel agent. The travel agent is not the entity at which the service will be delivered.

In other words, the transaction request message relates 112 to a transaction between the customer and the merchant. The transaction may be performed via a website of the merchant. In specific implementations, transaction device 102 may be fitted with a wireless communications interface such as a Near Field Communication (NFC) interface to enable the transaction device 102 to electronically communicate with the merchant device 104 to perform the transaction. NFC is a set of standards to establish radio communication between devices by bringing them into close proximity such as only a few centimetres. NFC standards cover communication protocols and data exchange formats, and are based on radio-frequency identification (RFID) technology.

The transaction device 102 is capable of wireless communication using a suitable protocol with the merchant device 104. For example, embodiments may be implemented using transaction devices 102 that are capable of communicating with WiFi/Bluetooth-enabled merchant devices 104. It will be appreciated by a person skilled in the art that depending on the wireless communication protocol used, appropriate handshaking procedures may need to be carried out to establish communication between the transaction device 102 and the merchant device 104. For example, in the case of Bluetooth communication, discovery and pairing of the transaction device 102 and the merchant device 104 may be carried out to establish communication.

The transaction request message 112 may include an indicator relating to the transaction device 102 and/or transaction data. Each transaction data relates to a transaction and identifies the customer and the merchant, generally by way of identifiers of each associated with the customer and merchant respectively. Further, the transaction data may also identify the good and/or service to be purchased and a type or nature of the transaction. The transaction data may further identify a value or price of the good and/or service (e.g., a transaction amount) and a location where the good and/or service will be delivered. The transaction data may also indicate a time and date at which the transaction was initiated.

The following types of transaction data may be included in the transaction request message 112:

Transaction Level Information:
Transaction ID
Account ID (anonymized)
Merchant ID
Transaction Amount
Transaction Local Currency Amount
Date of Transaction
Time of Transaction
Type of Transaction
Date of Processing
Cardholder Present Code

Account Information:
Account ID (anonymized)
Card Group Code
Card Product Code
Card Product Description
Card Issuer Country
Card Issuer ID
Card Issuer Name
Aggregate Card Issuer ID
Aggregate Card Issuer Name

Merchant Information:
Merchant ID
Merchant Name
MCC/Industry Code
Industry Description
Merchant Country
Merchant Address
Merchant Postal Code
Aggregate Merchant ID
Aggregate Merchant Name
Merchant Acquirer Country
Merchant Acquirer ID

Issuer Information:
Issuer ID
Issuer Name
Aggregate Issuer ID
Issuer Country

The transaction request message 112 is sent from the transaction device 102 to the merchant device 104. In a disclosed embodiment, for example where the transaction is being performed at the website of the merchant, the transaction device 102 and the merchant device 104 are in communication with a network, such as, the Internet (not shown for the sake of simplicity). In this example, the transaction request message 112 is sent from the transaction device 102 to the merchant device 104 via the network.

As mentioned above, the role of the payment network server 108 is to facilitate communication between the acquirer server 106 and the issuer server 110. Therefore, the payment network server 108 may serve as a means through which the acquirer server 106 may communicate with the issuer server 110 in order that payments and authentication may be performed. In specific implementations, the payment network server 108 may receive transaction data when settling a transaction for an account holder and subsequently store the transaction data in the database 109. Alternatively or additionally, the payment network service 108 may be configured to retrieve transaction data that is stored in the database 109 or the database 114.

The transaction authorization process described above involves multiple parties (e.g., account holder, merchant, acquirer, issuer, payment facilitator). However, the transaction authorization process may be essentially viewed as a transaction between an account holder and a merchant (with the other parties facilitating the transaction).

FIG. 2 shows a flow chart 200 illustrating a computer-implemented method for recommending a vacation option according to an example embodiment. At step 202, historical vacation transaction data, relating to a plurality of historical vacation transactions settled for the account holder, is retrieved by the payment network server 108. In the following description, “historical vacation transaction data” refers to data that is obtained as a result of a plurality of vacations taken by the account holder and may include, among other things, information relating to vacation destination, budget and weather of the destination. That is, historical vacation transaction data may be obtained to determine an account holder's potential vacation preferences and account holder's potential behaviour. In at least one example, historical vacation transaction data may include data as shown below (Table 1):

TABLE 1

| | | | Travel | | | |
|---|---|---|---|---|---|---|
| | | | Month and | | | |
| Account | | Vacation | Vacation | Venue | | Weather of |
| Holder | Origin | Destination | Duration | Characteristics | Budget | destination |
| A | Washington, | Miami, | June 2015 | Beaches, Water | $800 | Pleasant |
| | USA | USA | (3 days) | Sports | | |
| A | Washington, | Nice, | July 2014 | Beaches, Water | $2,500 | Pleasant |
| | USA | France | (5 days) | Sports | | |
| A | Washington, | Barcelona, | July 2015 | Beaches, Water | $2,700 | Pleasant |
| | USA | Spain | (7 days) | Sports | | |
| A | Washington, | Greenland | January 2015 | Snow, | $2,300 | Very Cold/ |
| | USA | | (3 days) | Mountains | | Snowy |
| A | Washington, | Switzerland | January 2014 | Snow, | $3,000 | Very Cold/ |
| | USA | | (6 days) | Mountains | | Snowy |
| B | Chicago, | New York, | October 2014 | Leisure | $1,500 | Fall |
| | USA | USA | (3 days) | | | |
| B | Chicago, | Boston, | October 2015 | Leisure | $800 | Fall |
| | USA | USA | (2 days) | | | |
| C | England | Las Vegas | October 2015 | Casino | $3,500 | Mild Cold |
| | | | (4 days) | | | |
| C | England | Monaco | September 2015 | Casino | $3,000 | Fall |
| | | | (5 days) | | | |
| D | India | Europe | July 2015 | Road Trip | $3,000 | Sunny |
| | | | (12 days) | | | |
| E | India | Goa | December 2014 | Sunburn | $2,000 | Sunny |
| | | | (4 days) | | | |
| E | India | Brussels, | June 2015 | Tomorrowland | $2,500 | Sunny |
| | | Belgium | (5 days) | | | |

In the example shown in Table 1, account holders A, B, C, D and E have taken vacations before and therefore generates vacation transaction data.

At step 204, the historical vacation transaction data is processed to identify a vacation budget that the account holder is likely to spend on vacation travel. The vacation budget refers to an amount that the account holder is likely to spend on vacation travel. In this context, historical vacation transaction data is processed to identify the amount that an account holder typically spends on vacation (or vacation travel) during a particular period of time. Referring to Table 1, account holder C typically spends between $15,000 and $20,000 on vacation and account holder B typically spends between $800 and $1,000. In an example, account holder C may be classified as a “High Spender” and account holder B may be classified as a “Low Spender”. Account holder E typically spends between $500 and $2,500 and may be classified as an “Average Spender”. Different rules may be applicable to the different classification of spenders. For example, high spenders may be those who travel in business class, stays in expensive hotels, have expensive food preference and spends more.

Further, the historical vacation transaction data is processed to identify vacation characteristics relating to the account holder. The payment network server may identify vacation transaction data based on the category of the associated merchant indicated in the historical vacation transaction data. For example, the payment network server may review merchant categories indicated in the historical vacation transaction data to determine whether any merchant is identified with a category commonly associated with vacation travel (e.g., airline merchants, rental car merchants, hotel merchants, golf merchants, restaurant merchants, and entertainment merchants). In one example, a database stores a correlation table that associates merchant categories with potential vacation travel. Such a correlation table may also indicate that particular merchant categories are more or less likely to be associated with vacation travel. For example, a merchant category of a resort destination may be very likely to be associated with vacation travel while a rental car may be somewhat likely to be associated with vacation travel. Similarly, a purchase of a set of golf clubs may be somewhat to be associated with vacation travel. In some examples, such correlation tables may also indicate the likelihood of association with vacation travel using a numeric indicator or score. In one example, the payment network server identifies a plurality of patronized merchant categories associated with each transaction relating to the historical vacation transaction data for the account holder, defines vacation merchant categories included within the plurality of patronized merchant categories wherein vacation merchant categories are categories of merchants that are associated with vacation travel, and identifies transaction data included within the vacation merchant categories as vacation transaction data.

For example, referring to Table 1, the vacation transaction data of account holder C (who is based in England) is associated with two regions—Las Vegas, the US and Monaco. Because of the timing of the purchases, the payment network server determines that account holder C travels when the weather of the destination is relatively cold. Such patterns may be used to determine part of account holder C's vacation behaviour. As a result, the payment network server determines that account holder C is interested in vacations involving travel for casino related activities even when the vacation requires significant distances of travel and during the third quarter of the year (e.g., September and October). The preferred weather under which the account holder has visited vacation venues and the preferred time period during which the account has visited such vacation venues are part of the vacation characteristics.

At step 206, a list of vacation options each associated with a budget that is within the identified vacation budget of the account holder is retrieved. In at least one example, the list of vacation options may include data as shown below (Table 2):

TABLE 2

| Account | Classi- | |
|---|---|---|
| holder | fication | Vacation Destination |
| C, P, Q | High | Macau, Las Vegas, Monaco, Paris, Istanbul, |
| | | Hawaii |
| A, R, S, Y, Z | Average | Finland, Austria, Barcelona, Miami, Nice, |
| | | Barcelona, Greenland, Switzerland, Caribbean |
| | | Island, London, Venice, Rio De Janerio |
| B, T, U, V | Low | Bangkok, Philippines, Goa, Orlando, Nice, |
| | | Miami, Boston, New York |

As mentioned in the above, account holder C may be classified as a “High Spender”, account holder B may be classified as a “Low Spender” and account holder E an “Average Spender”. For account holder C, vacation destinations visited by other account holders who are also classified as “High Spender” (e.g., P and Q) will be retrieved for account holder C. The list of vacation options retrieved for account holder C will include “Macau, Las Vegas, Monaco (FR), Paris, Istanbul, Hawaii”. It can be seen that these vacation options include destinations that have been visited by account holder C (e.g., Las Vegas, Monaco) and other destinations that have not been visited by account holder C (e.g., Macau, Paris, Istanbul and Hawaii). That is, the account holder may be introduced to a new vacation option for which he has not visited. In other words, the list of vacation options is used to identify vacation venues for which account holders having similar vacation spending behaviour like to travel so that similar places for vacations may be suggested to other account holders.

Monthly weather data and seasonality data may be retrieved for each of the vacation options listed in Table 2. The monthly weather data may indicate the type of weather for these vacation options for each month (e.g., snowy, cold, sunny) and may be retrieved from a third party database. The seasonality data may indicate a popularity index for a vacation option for each month. For example, Hawaii may be more likely to be popular during summer and less likely to be popular during winter. The seasonality data may be obtained from database 114. That is, the seasonality data may be obtained via recommendation-providing social media platforms such as Foursquare™ or Facebook™ or recommendation-providing websites such as TripAdvisor™. In another example, the seasonality data may be obtained based on historical vacation transaction data. That is, the historical vacation transaction data is processed to identify the time period that other account holders tend to visit a vacation option. In at least one example, the list of vacation options may include monthly weather data and seasonality data as shown below (Table 3):

TABLE 3

| | Month | | | | | | | | | | | |
|---|---|---|---|---|---|---|---|---|---|---|---|---|
| Place | January | Febuary | March | April | May | June | July | August | September | October | November | December |

| | |
|---|---|
| P1 | Weather |
| | Seasonality |
| P2 | Weather |
| | Seasonality |
| P3 | Weather |
| | Seasonality |
| P4 | Weather |
| | Seasonality |
| P5 | Weather |
| | Seasonality |
| P6 | Weather |
| | Seasonality |
| So on . . . | Weather |
| | Seasonality |

Referring to Table 1, account holder C is identified as one who is interested in vacations involving travel for casino related activities even when the vacation requires significant distances of travel. Based on this information, at least one venue option which is related to casino will be suggested to account holder. In at least one example, the recommended vacation options can be shown below (Table 4):

TABLE 4

| Cardholder | Suggested Places |
|---|---|
| A | Finland, Caribbean Islands, Austria |
| B | Orlando, Miami |
| C | Macau |

Further, account holder C may be identified as one who prefers to travel during the third quarter of the year (e.g., September and October) when it is colder. In other words, the preferred weather under which the account holder has visited vacation venues and the preferred time period during which the account has visited such vacation venues are part of the vacation characteristics that will be considered, as shown in the table below (Table 5).

TABLE 5

| Cardholder | Month | Weather |
|---|---|---|
| A | June/July | Pleasant |
| A | January | Very Cold/Snowy |
| B | October | Fall/Autumn |
| C | September-November | Cold/Mild Cold |
| D | July | Sunny |
| E | June/December | Sunny |

Combining the data presented in Table 4 and Table 5, the at least one vacation option in their preferred travel time and weather, as shown in the table below (Table 6).

TABLE 6

| Cardholder | Suggested Places | Time | Weather |
|---|---|---|---|
| A | Finland | January | Very Cold/Snowy |
| A | Austria | January | Very Cold/Snowy |
| A | Caribbean Islands | June/July | Pleasant |
| B | Orlando | September/October | Fall |
| B | Miami | September/October | Fall |
| C | Macau | November | Fall |

In an embodiment, vacation options may be proposed based on characteristics of a place. For example, if the place has more characteristics similar to places where the account holder has travelled before, there is a better chance for that place to be suggested. For e.g., account holder C has travelled to Las Vegas and Monaco to visit famous casinos in those cities. There are also famous casinos in Macau. Hence, it can be seen that, for account holder C, Macau will be recommended as a vacation option. This is because Macau is a place where casinos can be found and it is best travelled during November where it is not so crowded and is not so hot and humid.

In an implementation, historical transaction data is processed in step 204 to identify transactions that are initiated during a business travel and transactions that are initiated during a vacation. Various algorithms/rules may be applied. For example, the payment network server may identify business transaction data based on the category of the associated merchant indicated in the historical business transaction data. For example, the payment network server may review merchant categories indicated in the historical vacation transaction data to determine whether any merchant is identified with a category commonly associated with business travel. In one example, a database stores a correlation table that associates merchant categories with potential business travel. Such a correlation table may also indicate that particular merchant categories are more or less likely to be associated with business travel. In some examples, such correlation tables may also indicate the likelihood of association with business travel using a numeric indicator or score. Once transactions that are initiated during business travel are identified, they may be separated from vacation travel to increase the accuracy of recommending a vacation travel, since an account holder be obliged to travel to a particular place for travel which does not provide any useful information of his preference.

In one implementation, only historical transaction data that are generated by a consumer payment card is processed in step 204. In other words, historical transaction data that are generated by a corporate payment card will not be processed in step 204. This is made possible because each payment card has an unique bank identification number (BIN). The BIN refers to a number of digits (or characters) which identify an account issued by the issuer (for example, a bank). For example, in some embodiments an account (e.g. credit account, debit account, pre-paid account) is issued by an issuer pursuant to the MasterCard® International Incorporated rules, and the BIN may be a twelve to nineteen-digit string that identifies both the issuer (e.g. which may be based on the first few digits of the string, for example, the first five to ten digits) and the specific account (e.g. whether it is a consumer type account or a corporate type account). In other words, evaluation of the BIN makes it possible to eliminate business travel transactions to increase the accuracy of recommending a vacation travel. Those skilled in the art will appreciate that other primary account schemes and formats may be used in conjunction with embodiments described herein.

In another implementation, the vacation option that is recommended in step 208 is based on a relevance score. There may be more than one factor to tabulate the relevance score. A relevance score is one that indicates the relevance of the vacation option that is recommended. Various algorithms/rules may be applied to tabulate the relevance score. For each transaction that is made between the account holder and a merchant in relation to the vacation venue, the corresponding transaction data may include information such as the identity of the merchant (“Merchant name” or “Merchant ID”), time and date for which the goods/services relating to the transaction will be delivered, the type of industry (or industry-type) of the merchant delivering the goods/services and the time and date that the account holder may be at a certain venue. The relevance score may then be tabulated to indicate the relevance of the at least one vacation venue based on the identified vacation characteristics of the account holder. That is, if the vacation characteristics of the recommended vacation venue is a spa resort and the account holder often visits spa resorts during his past travels, the relevance score of the recommended vacation venue will be very high. In another example, if one merchant at the vacation venue has transactions with a high percentage of foreign visitors in the region, the relevance score of such merchant will be very high for other foreign visitors. In specific implementations, more than one vacation venue may be recommended, and the vacation venues are ranked based on the corresponding relevance scores. That is, a vacation venue which has a higher relevance score will be ranked before a vacation venue which has a lower relevance score.

Advantageously, the payment network server 108 may be configured to facilitate reducing advertising costs spent by vacation merchants due to marketing to account holders (or consumers) that are less interested in particular vacation products, identifying relevant vacation options to account holders and reducing time spent by account holders in identifying relevant vacation options.

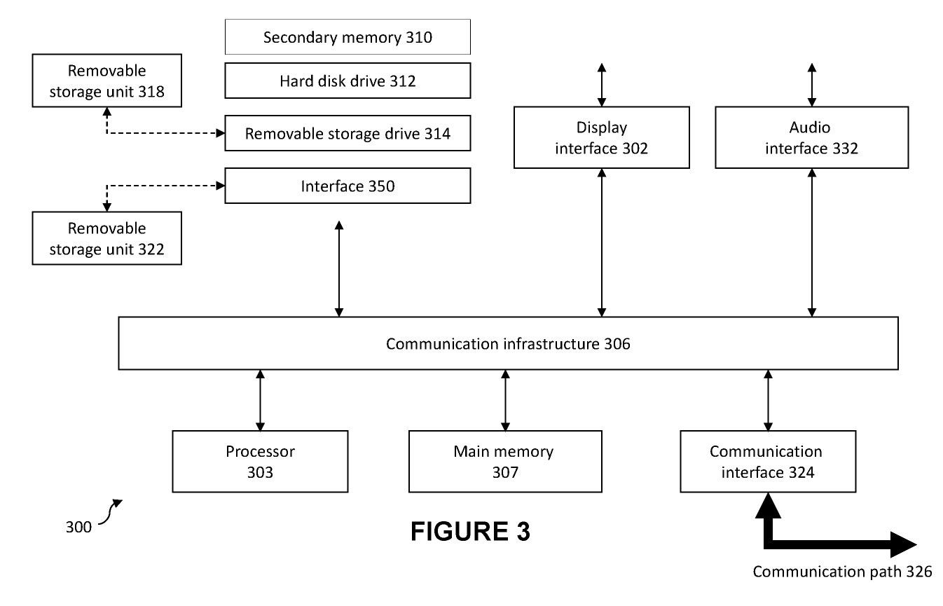

FIG. 3 depicts an exemplary computer/computing device 300, hereinafter interchangeably referred to as a computer system 300, where one or more such computing devices 300 may be used to facilitate execution of the above-described method for providing a travel recommendation to a user. In addition, one or more components of the computer system 300 may be used to realize the computer 302. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 340. Examples of a removable storage unit 322 and interface 340 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 340 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the inventions, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 400 using the removable storage drive 314, the storage drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

In an implementation, the payment network server 108 may be generally described as a physical device comprising at least one processor 402 and at least one memory 404 including computer program code. The at least one memory 404 and the computer program code are configured to, with the at least one processor 402, cause the physical device to perform the operations described in FIG. 2. An example of the payment network server 108 is shown in FIG. 4.

For example, the method of FIG. 2 may be implemented as software and stored in a non-transitory fashion in the secondary memory 310 or the removable storage units 318, 322 of the computer device 300.

It will be appreciated by a person skilled in the art that numerous variations and/or modifications may be made to the present invention as shown in the specific embodiments without departing from the spirit or scope of the invention as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

1. A computer-implemented method for recommending a vacation option for an account holder, comprising:
retrieving historical vacation transaction data relating to a plurality of historical vacation transactions settled for the account holder;
processing the historical vacation transaction data to identify vacation characteristics relating to the account holder and a vacation budget representing an amount that the account holder is likely to spend on vacation travel, the vacation characteristics indicating a preferred weather under which the account holder has visited vacation venues identified by the historical vacation transaction data and a preferred time period during which the account holder has visited the vacation venues;
retrieving a list of vacation options each associated with a budget that is within the identified vacation budget of the account holder; and
recommending a vacation option from the retrieved list of vacation options based on the identified vacation characteristics.

2. The method according to claim 1, wherein the step of processing the historical transaction data further comprises:
determining one merchant category in which the account holder has initiated at least a historical vacation transaction; and
determining a vacation type representing a category of vacation travel in which the account holder is interested based on the determined merchant category.

3. The method according to claim 2, wherein the step of recommending the vacation option further comprises selecting the vacation option that satisfies the determined vacation type.

4. The method according to claim 2, wherein the vacation budget is identified by determining an average expenditure that the account holder has spent on vacation based on the merchant category.

5. The method according to claim 1, wherein the vacation option is recommended based on a relevance score which indicates a relevance of the vacation option based on the identified vacation characteristics of the account holder.

6. The method according to claim 5, further comprising:
recommending a second vacation option from the retrieved list of vacation options based on the identified vacation characteristics of the account holder; and
assigning a relevance score to the second vacation option.

7. The method according to claim 6, further comprising:
ranking the vacation options based on the relevance scores.

8. The method according to claim 1, further comprising:
determining a popularity score for the time period during which the account holder has done the activities.

9. The method according to claim 8, wherein the step of recommending the vacation option is done based on the determined popularity score.

10. An apparatus recommending a vacation option for an account holder, comprising:
at least one processor; and
at least one memory including computer program code;
the at least one memory and the computer program code configured to, with at least one processor, cause the apparatus at least to:
retrieve historical vacation transaction data relating to a plurality of historical vacation transactions settled for the account holder;
process the historical vacation transaction data to identify vacation characteristics relating to the account holder and a vacation budget representing an amount that the account holder is likely to spend on vacation travel, the vacation characteristics indicating a preferred weather under which the account holder has visited vacation venues identified by the historical vacation transaction data and a preferred time period during which the account holder has visited the vacation venues;
retrieve a list of vacation options each associated with a budget that is within the identified vacation budget of the account holder; and
recommend a vacation option from the retrieved list of vacation options based on the identified vacation characteristics.

11. The apparatus according to claim 10, wherein the at least one memory and the computer program code is further configured with the at least one processor to:
determine one merchant category in which the account holder has initiated at least a historical vacation transaction; and
determine a vacation type representing a category of vacation travel in which the account holder is interested based on the determined merchant category.

12. The apparatus according to claim 10, wherein the at least one memory and the computer program code is further configured with the at least one processor to:
select the vacation option that satisfies the determined vacation type.

13. The apparatus according to claim 10, wherein the vacation budget is identified by determining an average expenditure that the account holder has spent on vacation based on the merchant category.

14. The apparatus according to claim 10, wherein the vacation option is recommended based on a relevance score which indicates a relevance of the vacation option based on the identified vacation characteristics of the account holder.

15. The apparatus according to claim 14, wherein the at least one memory and the computer program code is further configured with the at least one processor to:
recommend a second vacation option from the retrieved list of vacation options based on the identified vacation characteristics of the account holder; and
assign a relevance score to the second vacation option.

16. The apparatus according to claim 15, wherein the at least one memory and the computer program code is further configured with the at least one processor to:
rank the vacation options based on the relevance scores.

17. The apparatus according to claim 10, wherein the at least one memory and the computer program code is further configured with the at least one processor to:
determine a popularity score for the time period during which the account holder has visited the vacation venues.

18. The apparatus according to claim 17, wherein the at least one memory and the computer program code is further configured with the at least one processor to:
recommend the vacation option is done based on the determined popularity score.
